(19) United States
(12) Patent Application Publication
(10) Pub. No.: US 2015/0071596 A1
(43) Pub. Date: Mar. 12, 2015

(54) FIBER DISTRIBUTION HUB IN A FTTU MDU

(71) Applicant: CenturyLink Intellectual Property LLC, Denver, CO (US)

(72) Inventors: Michael Elford, Calhoun, LA (US); Joseph Fife, Littleton, CO (US)

(73) Assignee: CenturyLink Intellectual Property LLC, Denver, CO (US)

(21) Appl. No.: 14/181,073

(22) Filed: Feb. 14, 2014

Related U.S. Application Data
(60) Provisional application No. 61/876,116, filed on Sep. 10, 2013.

(51) Int. Cl. G02B 6/44

(52) U.S. Cl. CPC G02B 6/4441
USPC 385/135

(57) ABSTRACT

The present disclosure provides several embodiments of a tamper-resistant “secured” single fiber parking lot for a fiber line to prevent any injury by or tampering of a fiber line. For instance, one disclosed embodiment is a tamper-resistant secure single fiber hub that has a base and a removable lid that when coupled with the base forms an aperture operable to receive a fiber line. In one embodiment, the tamper-resistant secure single fiber hub further comprises a tamper-resistant lid screw for coupling the removable lid to the base, a retaining screw located within the cavity of the tamper-resistant secure single fiber hub for securing the fiber line to the fiber hub, a SC female connector type adapter operable to couple with a male connector located at an end of the fiber line, and an attachment screw for attaching the tamper-resistant secure single fiber hub to a media wiring box.

### CROSS REFERENCE TO RELATED APPLICATIONS

This application claims priority to U.S. Provisional Patent Application Ser. No. 61/876,116 filed on Sep. 10, 2013 entitled FIBER DISTRIBUTION HUB IN A FTTU MDU the entire teachings of which are incorporated herein.

### BACKGROUND OF THE INVENTION

1. Field of the Invention

The present invention generally relates to the field of communications, and in particular to a tamper-resistant “secured” single fiber parking lot for a fiber line.

2. Discussion of the Related Art

An optical fiber is a flexible, transparent fiber made of high quality extruded glass (silica) or plastic, slightly thicker than a human hair. It can function as a waveguide, or “light pipe” to transmit light between the two ends of the fiber. Optical fibers are widely used in fiber-optic communications, which permits transmission over longer distances and at higher bandwidths (data rates) than other forms of communication. Fibers are used instead of metal wires because signals travel along them with less loss and are also immune to electromagnetic interference.

### SUMMARY OF THE INVENTION

The present disclosure provides several embodiments of a tamper-resistant “secured” single fiber parking lot for a fiber line to prevent any injury by or tampering of a fiber line.

For example, one disclosed embodiment is a tamper-resistant secure single fiber hub comprising a base and a removable lid that when coupled with the base forms an aperture operable to receive a fiber line; and further comprising a tamper-resistant lid screw for coupling the removable lid to the base, a retaining screw located within the cavity of the tamper-resistant secure single fiber hub for securing the fiber line to the tamper-resistant secure single fiber hub, a SC female connector type adapter operable to couple with a male connector located at an end of the fiber line, and an attachment screw for attaching the tamper-resistant secure single fiber hub to a media wiring box.

A second disclosed embodiment is a tamper-resistant secure single fiber apparatus comprising a base enclosure having an aperture for receiving a fiber line; a bend limiter for winding the fiber line about a spool for creating a taut fiber line, wherein the bend limiter is an interchangeable component of the tamper-resistant secure single fiber apparatus for enabling varying lengths of the fiber line to be stored; a hinged lid configured to enclose the base enclosure; a female parking lot for coupling to a male end of the fiber line; a rubber friction stopper for securing the end of the fiber line; and a tamper-resistant lid screw for securing the lid to the base enclosure.

Still, a third disclosed embodiment is a tamper-resistant secured single fiber parking lot comprising a base; a lid; a hinge coupling the base and the lid at a first end of the base and the lid; an aperture on a second end of the base and the lid for receiving a fiber line; a center pin configured for enabling the fiber line to be wrapped around the center pin for securing the fiber line to the tamper-resistant secured single fiber parking lot; a female parking lot adapter for coupling with a male connector coupled to the fiber line; and a securing means for securely coupling the base and the lid together.

Other embodiments and advantages of the disclosed embodiments are set forth in the detailed descriptions.

### BRIEF DESCRIPTION OF THE DRAWINGS

Illustrative embodiments of the present invention are described in detail below with reference to the attached drawing figures, which are incorporated by reference herein and wherein:

FIGS. 1A-1C illustrate a first embodiment of a tamper-resistant secured single fiber parking lot for a fiber line;

FIG. 2 is a diagram that illustrates a second embodiment of a tamper-resistant secured single fiber parking lot for a fiber line;

FIGS. 3A-3D illustrate a third embodiment of a tamper-resistant secured single fiber parking lot for a fiber line; and

FIG. 4 is a diagram that illustrates a fourth embodiment of a tamper-resistant secured single fiber parking lot for a fiber line.

### DETAILED DESCRIPTION

The disclosed embodiments seek to provide one or more solutions to a potential safety problem associated with Fiber Distribution in a Fiber to the User (FTTU) Multi-Dwelling Unit (MDU) environment. Non-limiting examples of MDUs include apartment complex, office buildings, condos, and student-housing.

Typically, in a single dwelling environment (e.g., a house), a fiber line is delivered to an Optical Network Terminal (ONT) (usually connected to external wall of the dwelling) that converts fiber-optic light signals to copper/electric signals that are then transferred inside the dwelling via coax cables. However, because coax cables can run for a max length of around 300 feet before the signal degrades, in some MDU environments, the fiber line is ran directly to a user/unit (e.g., directly to an apartment unit in a large apartment type tower building). This presents a potential safety problem because currently, gigabit passive optical networks (GPON) must be fully enabled all the way back to the PON ports. With fiber going directly to the unit, this would result in all the glass/fiber lines being lit into all the apartments even when not in use, thus creating a potential danger to unwary consumers. It is unlikely that caution stickers alone will prevent the innocent from looking into the light and damaging their eyesight while investigating the structured wire enclosure in their unit. Accordingly, the present disclosure provides several embodiments of a tamper-resistant “secured” single fiber parking lot for a fiber line to prevent any injury by or tampering of a fiber line.

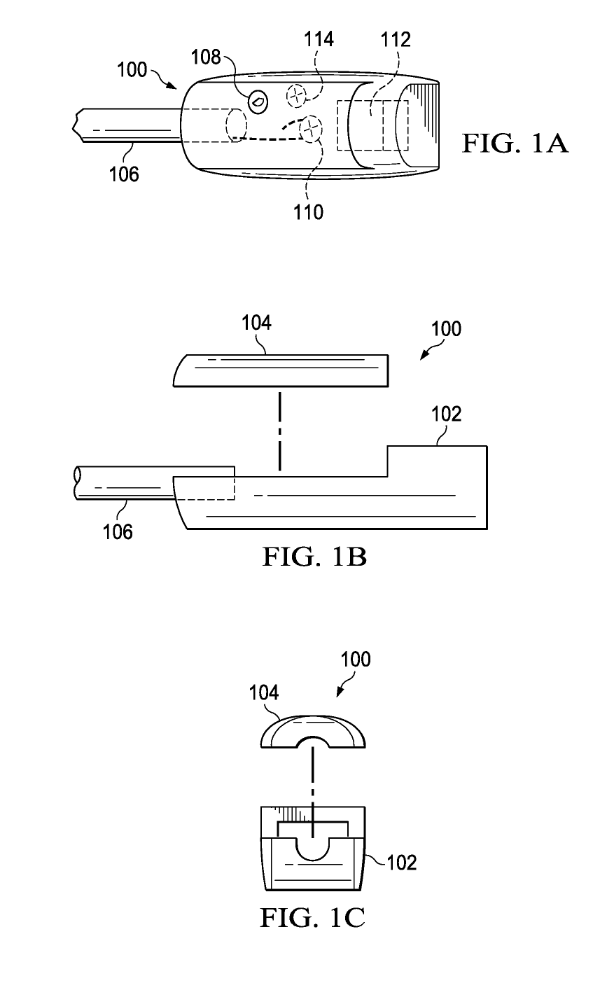

The disclosed embodiments and advantages thereof are best understood by referring to FIGS. 1-4 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, elements, and/or components, but do not preclude the presence or addition of one or more other features, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. The embodiments were chosen and described to explain the principles of the invention and the practical application, and to enable others of ordinary skill in the art to understand the claimed inventions.

Beginning with FIGS. 1A-1C, a first embodiment of a tamper-resistant “secured” single fiber parking lot 100 for a fiber line is presented. As depicted, the tamper-resistant device 100 comprises of a base 102 and a removable lid 104 that when coupled together forms an aperture in which the fiber line 106 is received. In one embodiment, the base 102 and the removable lid 104 are made of a hard plastic material.

In one embodiment, the tamper-resistant device 100 includes a tamper-resistant lid screw 108 for coupling the removable lid 104 to the base 102. A special device would be needed to unscrew the tamper-resistant lid screw 108. This prevents a user from opening the tamper-resistant device 100.

Additionally, in certain embodiments, the tamper-resistant device 100 includes a retaining screw 110 that may be used for securing the fiber line 106 to prevent the user from pulling the fiber line 106 out of the tamper-resistant device 100. For example, as depicted in FIG. 1A, in one embodiment, the Kevlar® fibers inside the fiber line 106 may be wrapped around and fastened to the retraining screw 110.

In addition, in certain embodiments, to prevent the fiber line 106 from moving within the tamper-resistant device 100 and potential damaging the fiber line 106, a male connector coupled to the end of the fiber line 106 may be attached to a female parking lot 112. In one embodiment, the female parking lot 112 may be SC female connector type adapter. However, the disclosed embodiments are not limited to a particular type of connector.

Still, in certain embodiments, the tamper-resistant device 100 may include an attachment screw 114 for attaching the tamper-resistant device 100 to a media panel or other types of wiring boxes within a user's unit.

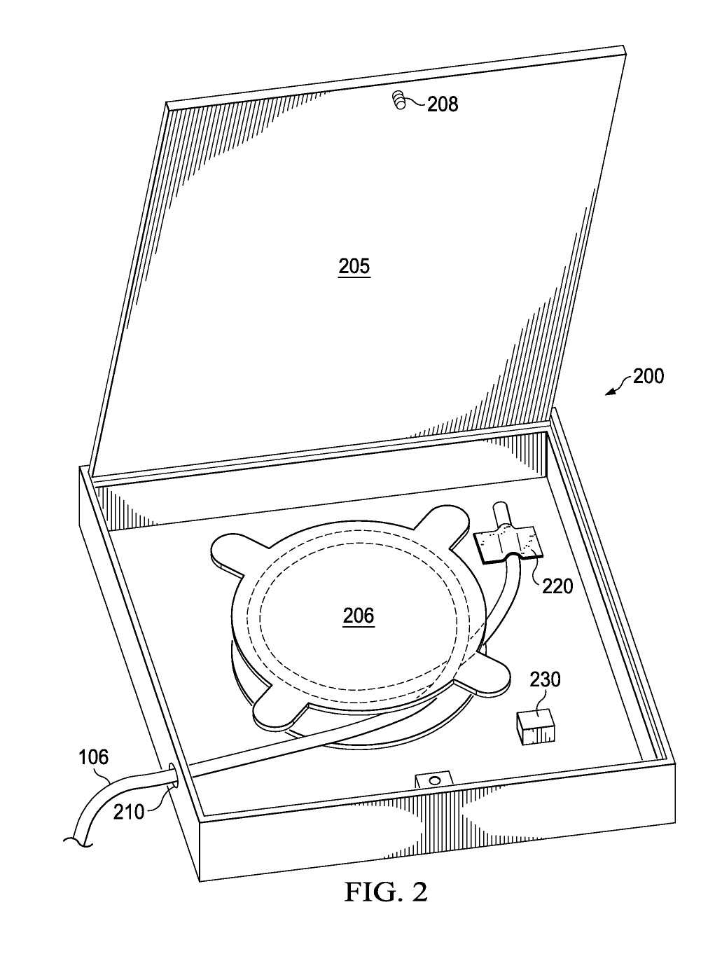

FIG. 2 is a diagram that illustrates a second embodiment of a tamper-resistant “secured” single fiber parking lot for a fiber line. In this embodiment, a tamper-resistant device 200 comprises of a boxlike (i.e., rectangular and/or square shaped) enclosure having an aperture 210 for receiving the fiber line 106. In certain embodiments, the tamper-resistant device 200 includes a bend limiter 206 that is used for winding the fiber line 106 about a spool for creating a taut fiber line. The size/diameter of the bend limiter 206 may vary with different embodiments to enable a certain amount of the fiber line 106 to be contained within the tamper-resistant device 200. For example, in certain embodiments, the tamper-resistant device 200 may contain 2 to 3 meters of fiber line. In certain embodiments, the bend limiter 206 may be a removable/interchangeable component of the tamper-resistant device 200 for enabling varying lengths of the fiber line to be stored.

In one embodiment, the open end of the fiber line 106 is fed through a rubber friction stopper 220 for securing the end of the fiber line 106. Alternatively, or in addition to, in certain embodiments, the tamper-resistant device 200 includes a female parking lot 230 for coupling to a male end of the fiber line 106 as similar described above. In these embodiments, the thickness of the tamper-resistant device 200 would be greater than the length of the connector (e.g., an SC fiber line connector). The tamper-resistant device 200 includes a lid 205 that encloses the tamper-resistant device 200 and is secured by a tamper-resistant lid screw 208. In the disclosed embodiment, the lid 205 is connected to the base enclosure of the tamper-resistant device 200 using a hinge. However, in certain embodiments, the lid 205 may be a removable non-hinged lid that is securely fastened to the base enclosure of the tamper-resistant device 200.

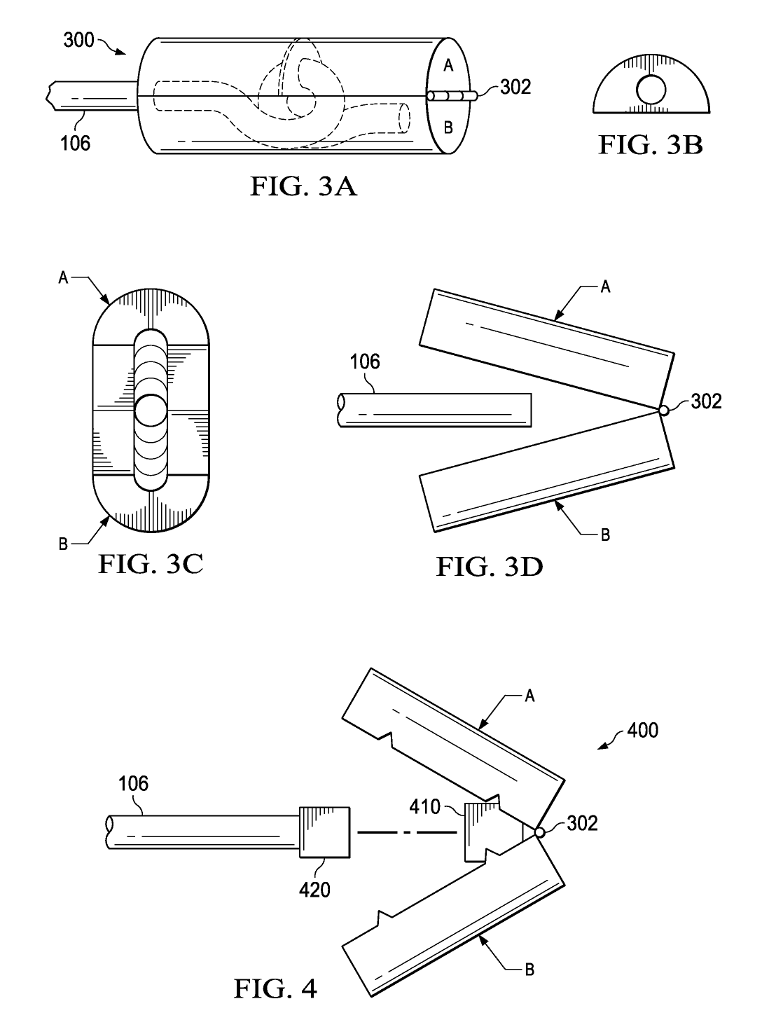

FIGS. 3A-3D illustrate a third embodiment of a tamper-resistant “secured” single fiber parking lot for a fiber line. In this embodiment, a tamper-resistant device 300 comprises of a base B and a lid A held together at a first end by a hinge 302 that when coupled together forms an aperture on a second end of the tamper-resistant device 300 for receiving the fiber line 106. In this embodiment, one of the halves (A or B) includes a center pin 310 in which the fiber line 106 is wrapped around for securing the fiber line 106 to the tamper-resistant device 300. Additionally, a compression fit around the end of the fiber line 106 creates a tight friction on the fiber line 106 for further preventing the fiber line 106 from being removed. Although not depicted, the tamper-resistant device 300 would include either a tamper-resistant screw or latch for securing the 2 halves of the tamper-resistant device 300 together. Particular advantages of this embodiment is that it would be cheaper to produce, take less time to install, and would require no special equipment for installation.

FIG. 4 is a diagram that illustrates a fourth embodiment of the tamper-resistant of a tamper-resistant “secured” single fiber parking lot for a fiber line. In this embodiment, a tamper-resistant device 400 is disclosed that is similar to the tamper-resistant device 300 except it includes a female parking lot adapter 410 (e.g., for SC, APC, UPC type connectors) for coupling with a male connector 420 coupled to the fiber line 106. Again, the tamper-resistant device 400 would include a latch or other tamper-resistant means for securing the fiber line 106 and preventing the opening of the tamper-resistant device 400 by a user.

While specific details about the above embodiments have been described, the above descriptions are intended merely as example embodiments and are not intended to limit the structure or implementation of the disclosed embodiments. In addition to the embodiments described above, many examples of specific combinations are within the scope of the disclosure, some of which are summarized in the following example embodiments.

Example 1 is a tamper-resistant secure single fiber hub comprising a base and a removable lid that when coupled with the base forms an aperture operable to receive a fiber line.

Example 2 is a tamper-resistant secure single fiber hub comprising a base and a removable lid that when coupled with the base forms an aperture operable to receive a fiber line, wherein the base and the removable lid are made of a hard plastic material.

Example 3 is a tamper-resistant secure single fiber hub comprising a base and a removable lid that when coupled with the base forms an aperture operable to receive a fiber line, and further comprising a tamper-resistant lid screw for coupling the removable lid to the base.

Example 4 is a tamper-resistant secure single fiber hub comprising a base and a removable lid that when coupled with the base forms an aperture operable to receive a fiber line; and further comprising a retaining screw located within the cavity of the tamper-resistant secure single fiber hub for securing the fiber line to the tamper-resistant secure single fiber hub.

Example 5 is a tamper-resistant secure single fiber hub comprising a base and a removable lid that when coupled with the base forms an aperture operable to receive a fiber line; and further comprising a female parking lot operable to couple with a male connector located at an end of the fiber line.

Example 6 is a tamper-resistant secure single fiber hub comprising a base and a removable lid that when coupled with the base forms an aperture operable to receive a fiber line; and further comprising a female parking lot operable to couple with a male connector located at an end of the fiber line, wherein the female parking lot is a SC female connector type adapter.

Example 7 is a tamper-resistant secure single fiber hub comprising a base and a removable lid that when coupled with the base forms an aperture operable to receive a fiber line; and further comprising an attachment screw for attaching the tamper-resistant secure single fiber hub to a media wiring box.

Example 8 is a tamper-resistant secure single fiber hub comprising a base and a removable lid that when coupled with the base forms an aperture operable to receive a fiber line; and further comprising a tamper-resistant lid screw for coupling the removable lid to the base, a retaining screw located within the cavity of the tamper-resistant secure single fiber hub for securing the fiber line to the tamper-resistant secure single fiber hub, a SC female connector type adapter operable to couple with a male connector located at an end of the fiber line, and an attachment screw for attaching the tamper-resistant secure single fiber hub to a media wiring box.

Example 9 is a tamper-resistant secure single fiber apparatus comprising a base enclosure having an aperture for receiving a fiber line; a bend limiter for winding the fiber line about a spool for creating a taut fiber line; a lid configured to enclose the base enclosure; and a tamper-resistant lid screw for securing the lid to the base enclosure.

Example 10 is a tamper-resistant secure single fiber apparatus comprising a base enclosure having an aperture for receiving a fiber line; a bend limiter for winding the fiber line about a spool for creating a taut fiber line, wherein the bend limiter is an interchangeable component of the tamper-resistant secure single fiber apparatus for enabling varying lengths of the fiber line to be stored; a lid configured to enclose the base enclosure; and a tamper-resistant lid screw for securing the lid to the base enclosure.

Example 11 is a tamper-resistant secure single fiber apparatus comprising a base enclosure having an aperture for receiving a fiber line; a bend limiter for winding the fiber line about a spool for creating a taut fiber line; a lid configured to enclose the base enclosure; a tamper-resistant lid screw for securing the lid to the base enclosure; and a female parking lot for coupling to a male end of the fiber line.

Example 12 is a tamper-resistant secure single fiber apparatus comprising a rectangular base enclosure having an aperture for receiving a fiber line; a bend limiter for winding the fiber line about a spool for creating a taut fiber line, wherein the bend limiter is an interchangeable component of the tamper-resistant secure single fiber apparatus for enabling varying lengths of the fiber line to be stored; a lid configured to enclose the base enclosure; and a tamper-resistant lid screw for securing the lid to the base enclosure.

Example 13 is a tamper-resistant secure single fiber apparatus comprising a square base enclosure having an aperture for receiving a fiber line; a bend limiter for winding the fiber line about a spool for creating a taut fiber line, wherein the bend limiter is an interchangeable component of the tamper-resistant secure single fiber apparatus for enabling varying lengths of the fiber line to be stored; a lid configured to enclose the base enclosure; and a tamper-resistant lid screw for securing the lid to the base enclosure.

Example 14 is a tamper-resistant secure single fiber apparatus comprising a base enclosure having an aperture for receiving a fiber line; a bend limiter for winding the fiber line about a spool for creating a taut fiber line, wherein the bend limiter is an interchangeable component of the tamper-resistant secure single fiber apparatus for enabling varying lengths of the fiber line to be stored; a lid configured to enclose the base enclosure, wherein the lid is coupled to the base enclosure using a hinge; and a tamper-resistant lid screw for securing the lid to the base enclosure.

Example 15 is a tamper-resistant secure single fiber apparatus comprising a base enclosure having an aperture for receiving a fiber line; a bend limiter for winding the fiber line about a spool for creating a taut fiber line, wherein the bend limiter is an interchangeable component of the tamper-resistant secure single fiber apparatus for enabling varying lengths of the fiber line to be stored; a removable lid configured to enclose the base enclosure; and a tamper-resistant lid screw for securing the lid to the base enclosure.

Example 16 is a tamper-resistant secure single fiber apparatus comprising a base enclosure having an aperture for receiving a fiber line; a bend limiter for winding the fiber line about a spool for creating a taut fiber line, wherein the bend limiter is an interchangeable component of the tamper-resistant secure single fiber apparatus for enabling varying lengths of the fiber line to be stored; a lid configured to enclose the base enclosure; a rubber friction stopper for securing the end of the fiber line; and a tamper-resistant lid screw for securing the lid to the base enclosure.

Example 17 is a tamper-resistant secure single fiber apparatus comprising: a base enclosure having an aperture for receiving a fiber line; a bend limiter for winding the fiber line about a spool for creating a taut fiber line, wherein the bend limiter is an interchangeable component of the tamper-resistant secure single fiber apparatus for enabling varying lengths of the fiber line to be stored; a hinged lid configured to enclose the base enclosure; a female parking lot for coupling to a male end of the fiber line; a rubber friction stopper for securing the end of the fiber line; and a tamper-resistant lid screw for securing the lid to the base enclosure.

Example 18 is a tamper-resistant secured single fiber parking lot comprising: a base; a lid; a hinge coupling the base and the lid at a first end of the base and the lid; an aperture on a second end of the base and the lid for receiving a fiber line; and a securing means for securely coupling the base and the lid together.

Example 19 is a tamper-resistant secured single fiber parking lot comprising: a base; a lid; a hinge coupling the base and the lid at a first end of the base and the lid; an aperture on a second end of the base and the lid for receiving a fiber line; a center pin configured for enabling the fiber line to be wrapped around the center pin for securing the fiber line to the tamper-resistant secured single fiber parking lot; and a securing means for securely coupling the base and the lid together.

Example 20 is a tamper-resistant secured single fiber parking lot comprising: a base; a lid; a hinge coupling the base and the lid at a first end of the base and the lid; an aperture on a second end of the base and the lid for receiving a fiber line; and a tamper-resistant screw for securely coupling the base and the lid together.

Example 21 is a tamper-resistant secured single fiber parking lot comprising: a base; a lid; a hinge coupling the base and the lid at a first end of the base and the lid; an aperture on a second end of the base and the lid for receiving a fiber line; and tamper-resistant latch for securely coupling the base and the lid together.

Example 22 is a tamper-resistant secured single fiber parking lot comprising: a base; a lid; a hinge coupling the base and the lid at a first end of the base and the lid; an aperture on a second end of the base and the lid for receiving a fiber line; a center pin configured for enabling the fiber line to be wrapped around the center pin for securing the fiber line to the tamper-resistant secured single fiber parking lot; a female parking lot adapter for coupling with a male connector coupled to the fiber line and a securing means for securely coupling the base and the lid together.

Example 23 is a tamper-resistant secured single fiber parking lot comprising: a base; a lid; a hinge coupling the base and the lid at a first end of the base and the lid; an aperture on a second end of the base and the lid for receiving a fiber line; a center pin configured for enabling the fiber line to be wrapped around the center pin for securing the fiber line to the tamper-resistant secured single fiber parking lot; a female parking lot adapter for coupling with a male connector coupled to the fiber line; and a securing means for securely coupling the base and the lid together.

Many modifications and variations will be apparent to those of ordinary skill in the art without departing from the scope and spirit of the disclosed embodiments. The scope of the claims is intended to broadly cover the disclosed embodiments and any such modification.

1. A tamper-resistant secure single fiber hub comprising:
a base; and
a removable lid that when coupled with the base forms an aperture operable to receive a fiber line.

2. The tamper-resistant secure single fiber hub of claim 1, wherein the base and the removable lid are made of a hard plastic material.

3. The tamper-resistant secure single fiber hub of claim 1, further comprising a tamper-resistant lid screw for coupling the removable lid to the base.

4. The tamper-resistant secure single fiber hub of claim 1, further comprising a retaining screw located within the cavity of the tamper-resistant secure single fiber hub for securing the fiber line to the tamper-resistant secure single fiber hub.

5. The tamper-resistant secure single fiber hub of claim 1, further comprising a female parking lot operable to couple with a male connector located at an end of the fiber line.

6. The tamper-resistant secure single fiber hub of claim 5, wherein the female parking lot is a SC female connector type adapter.

7. The tamper-resistant secure single fiber hub of claim 1, further comprising an attachment screw for attaching the tamper-resistant secure single fiber hub to a media wiring box.

8. A tamper-resistant secure single fiber apparatus comprising:
a base enclosure having an aperture for receiving a fiber line;
a bend limiter for winding the fiber line about a spool for creating a taut fiber line;
a lid configured to enclose the base enclosure; and
a tamper-resistant lid screw for securing the lid to the base enclosure.

9. The tamper-resistant secure single fiber apparatus of claim 8, wherein the bend limiter is an interchangeable component of the tamper-resistant secure single fiber apparatus for enabling varying lengths of the fiber line to be stored.

10. The tamper-resistant secure single fiber apparatus of claim 8, further comprising a female parking lot for coupling to a male end of the fiber line.

11. The tamper-resistant secure single fiber apparatus of claim 8, wherein the base enclosure is rectangular shape.

12. The tamper-resistant secure single fiber apparatus of claim 8, wherein the base enclosure is square shape.

13. The tamper-resistant secure single fiber apparatus of claim 8, wherein the lid is coupled to the base enclosure using a hinge.

14. The tamper-resistant secure single fiber apparatus of claim 8, wherein the lid is a removable lid.

15. The tamper-resistant secure single fiber apparatus of claim 8, further a rubber friction stopper for securing the end of the fiber line.

16. A tamper-resistant secured single fiber parking lot comprising:
a base;
a lid;
a hinge coupling the base and the lid at a first end of the base and the lid;
an aperture on a second end of the base and the lid for receiving a fiber line; and
a securing means for securely coupling the base and the lid together.

17. The tamper-resistant secured single fiber parking lot of claim 16, further comprising a center pin configured for enabling the fiber line to be wrapped around the center pin for securing the fiber line to the tamper-resistant secured single fiber parking lot.

18. The tamper-resistant secured single fiber parking lot of claim 16, wherein the securing means is a tamper-resistant screw.

19. The tamper-resistant secured single fiber parking lot of claim 16, wherein the securing means is a tamper-resistant latch.

20. The tamper-resistant secured single fiber parking lot of claim 16, further comprising a female parking lot adapter for coupling with a male connector coupled to the fiber line.
